(19) United States
(12) Patent Application Publication
(10) Pub. No.: US 2012/0167163 A1
(43) Pub. Date: Jun. 28, 2012

(54) APPARATUS AND METHOD FOR QUANTITATIVELY EVALUATING SECURITY POLICY

(75) Inventors: Sun Hee Lim, Daejeon (KR); Gaeil An, Daejeon (KR); Sungwon Yi, Daejeon (KR); Ki Young Kim, Daejeon (KR); Jonghyun Kim, Daejeon (KR); Dong il Seo, Daejeon (KR)

(73) Assignee: Electronics and Telecommunications Research Institute, Daejeon (KR)

(21) Appl. No.: 13/324,482

(22) Filed: Dec. 13, 2011

(30) Foreign Application Priority Data
Dec. 22, 2010 (KR) 10-2010-0132217

(51) Int. Cl. G06F 21/00

(52) U.S. Cl. 726/1

(57) ABSTRACT

An apparatus for quantitatively evaluating security policy includes: a security policy analyzing unit for analyzing a security policy of a network; an evaluation criterion defining unit for defining an evaluation criterion for categorizing security features and evaluating each of the security features; an evaluation result calculating unit for calculating an evaluation result of each of security components based on the evaluation criterion; an indicator calculating unit for grouping the security components according to a security function and calculating an indicator by considering a security function of each group; and a quantitative evaluating unit for evaluating a security policy of the each group by using the indicator.

### CROSS-REFERENCE(S) TO RELATED APPLICATION(S)

The present invention claims priority of Korean Patent Application No. 10-2010-0132217, filed on Dec. 22, 2010, which is incorporated herein by reference.

### FIELD OF THE INVENTION

The present invention relates to evaluating security policy; and more particularly, to an apparatus and method for quantitatively and effectively evaluating security policy which is combined by various security components by proposing a unified evaluation criterion and a stereotypical security evaluation model.

### BACKGROUND OF THE INVENTION

Generally, a security policy evaluation for evaluating a security policy for a security components and expressing a level of a current security policy is preformed according to an individual policy which is set in each network.

In the conventional security evaluation method, a security policy evaluation is performed by a simple accumulation based on an evaluation result according to whether each of the security components satisfies security features in order to evaluate quantitatively a security component composed of various security components.

However, problems about an evaluation criterion, an evaluation element and an evaluation method are found in the conventional security evaluation technology since the security polices in network of the communication service providers are composed of various security components.

Especially, since the security evaluation is performed by applying simple accumulative function to the security components to be evaluated, the conventional security evaluation has a problem that a security policy composed of a plurality of weak security components can be evaluated to be better than a security policy composed of a few safe security components.

When such problems are occurred, a method for amending the evaluation result of the security component arbitrarily is used conventionally. However, since all evaluation features, criteria and methods should be modified when the security components constituting the security policy are increased, the conventional security evaluation method cannot be efficient method as a quantitative evaluation method.

### SUMMARY OF THE INVENTION

In view of the above, the present invention provides an apparatus and method for evaluating quantitatively and effectively security policy combined by various security components by proposing a unified evaluation criterion and a stereotypical security evaluation model in an environment where various security policies are being defined in order to support a security interworking service between various heterogeneous networks including an interworking between combined wire-wireless networks such as a heterogeneous network in addition to an interworking between different communication service providers as an inter-domain.

In accordance with an aspect of the present invention, there is provided an apparatus for quantitatively evaluating security policy, including:

a security policy analyzing unit for analyzing a security policy of a network;

an evaluation criterion defining unit for defining an evaluation criterion for categorizing security features as evaluation feature and evaluating each of the security features;

an evaluation result calculating unit for calculating an evaluation result of each of security components based on the evaluation criterion for each of the security features;

an indicator calculating unit for categorizing and grouping the security components according to a security function and calculating an indicator by considering a security function of each group; and

a quantitative evaluating unit for evaluating a security policy of the each group by using the indicator.

In accordance with another aspect of the present invention, there is provided a method for quantitatively evaluating security policy, including:

analyzing a security policy of a network;

defining an evaluation criterion for categorizing security features as an evaluation feature and evaluating each of the security features;

calculating an evaluation result of each security component based on the evaluation criterion for each of the security features;

categorizing and grouping the security component according to a security function and calculating an indicator by considering the security function of each group; and

evaluating quantitatively a security policy of the each group by using the indicator.

### BRIEF DESCRIPTION OF THE DRAWINGS

The objects and features of the present invention will become apparent from the following description of embodiments, given in conjunction with the accompanying drawings, in which:

FIG. 1 shows a specific block diagram of an apparatus for quantitatively evaluating security policy according to an embodiment of the present invention.

FIG. 2 illustrates a flow chart for evaluating quantitatively a security policy of network according to an embodiment of the present invention.

### DETAILED DESCRIPTION OF THE EMBODIMENTS

Hereinafter, embodiments of the present invention will be described with reference to the accompanying drawings which form a part hereof.

At present, security policies become indispensable requisites in various fields. In addition, various policies are combined organically in order to satisfy various security components instead of applying a unified security policy. Especially, while an interworking between heterogeneous devices is required in a network environment getting out of single platform environment, evaluation results obtained by analyzing a security policy defined in each network and evaluating quantitatively the security policy are necessary for a security interworking of a effective and uniform level.

Security polices which are defined independently by each of networks requires various security components such as an authentication, a confidentiality, an access control, and a vulnerability analysis.

Each of security components is combined to define single security policy in order to satisfy such essential security components. It is provided an apparatus and method for quantitatively evaluating security policy based on a conventional quality of protection (QoP) model as a quantitatively evaluation method for interacting security components according to the embodiment of the present invention.

Here, the Qop model is a model for measuring the intensity of a security protocol. The Qop model can be composed of a utility function as a method for evaluating the security components in a microscopic view point and a total reward function for evaluating each of the security policies in a macroscopic view point based on the values of the utility function.

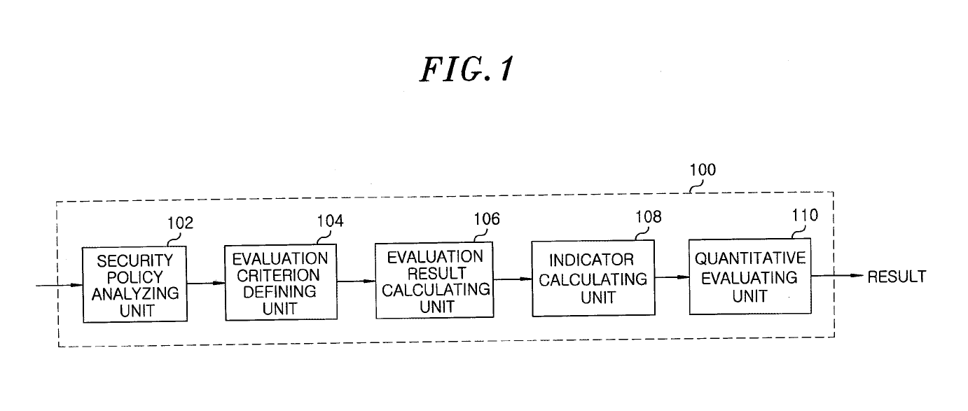

FIG. 1 shows a specific block diagram of an apparatus for quantitatively evaluating security policy according to an embodiment of the present invention. The apparatus 100 includes a security policy analyzing unit 102, an evaluation criterion defining unit 104, an evaluation result calculating unit 106, an indicator calculating unit 108 and a quantitative evaluating unit 110.

Hereinafter, the apparatus for quantitatively evaluating security policy according to an embodiment of the present invention will be described specifically with reference to FIG. 1.

Firstly, the security policy analyzing unit 102 analyzes a security policy composed of combined various security components in heterogeneous networks and categorizes minimum security component.

The evaluation criterion defining unit 104 categorizes security features as an evaluation feature and defines evaluation criteria for evaluating each of security features.

The evaluation result calculating unit 106 digitizes each of the security components by using the utility function based on the evaluation criteria for each of the security features and calculates an evaluation result as a result value by putting together the numerical values of the utility function.

The indicator calculating unit 108 categorizes and groups the security components, which are evaluated in the evaluation result calculating unit 106 by using the utility function, according to a security function, and calculates an indicator value in the point of the security function of each group.

The quantitative evaluating unit 110 extracts a data set which is suitable for the priority of the security policies based on the security function which is defined in the grouping process of the security components by using the indicator value of each group of the security components, the indicator value being calculated by the indicator calculating unit 108. Then, the quantitative evaluating unit 110 evaluates the security policies composed of combined various security components and determines ranking of the security policies.

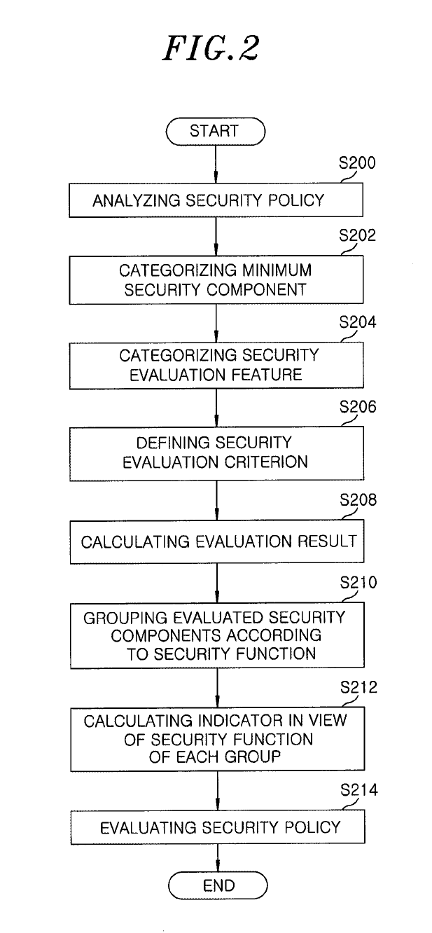

FIG. 2 illustrates a flow chart for an operation of evaluating quantitatively security policies composed of combined various security components in an apparatus for evaluating quantitatively security policy according to the embodiment of the present invention. Hereinafter, the embodiment of the present invention will be described with reference to FIGS. 1 and 2.

Firstly, the security policy analyzing unit 102 analyzes a security policy defined in each network in step S200. Namely, the security policy analyzing unit 102 analyzes a security policy composed of combined various security components and categorizes minimum security component as a method for evaluating quantitatively security policy according to the present invention in step S202.

As described above, when the security policy is categorized into the minimum security component by the security policy analysis in step S204, the evaluation criterion defining unit 104 categorizes the security features as an evaluation feature and defines evaluation criterion for evaluating each of security features in step S206.

When the evaluation criterion are defined as described above, the evaluation result calculation unit 106 calculates an evaluation result by evaluating each of the security components based on the evaluation criterion for each of the security features through the utility function in step S208. Here, the evaluation result calculation unit 106 digitizes each of the security components by using the utility function and calculates the evaluation results by putting together the numerical values of the utility function.

When the evaluation result is calculated, the indicator calculating unit 108 categorizes and groups the security components, which are evaluated in the evaluation result calculating unit 106 by using the utility function, according to a security function in step S210, and calculates an indicator value in point of the security function of each group in step S212.

The indicator value solves a problem that security polices having different characteristics have the same result by using the total reward function such as the following mathematical equation 1 which is defined as a conventional simple accumulative function.

$$Φ ( P ) = {\sum }_{k = 1}^{n} \{ {\sum }_{i = 1}^{m} {v}_{i}^{k} {w}_{i} \} \qquad [ Mathematical Equation 1 ]$$

where vᵢ^{k} is an evaluation feature.

Namely, the total reward function defined as the conventional simple accumulative function has a problem that value of 1 is allocated in case that the security function is supported and otherwise value of 0 is allocated so that the security policies having different characteristics have the same result and are evaluated identically. The embodiment of the present invention solves the problem by applying the indicator value to security components which are categorized and group according to the security function.

Since each of the security components has a characteristic based on the security function thereof, the indicator calculating unit 108 groups the security components having a similar function and adjusts the indicator value based on the security function of each group. Here, the indicator value is not a value which a manager allocates arbitrarily or based on his or her experience. Rather, the indicator value is a data set which is suitable for the priority of the security policies based on the security function which is defined in the grouping process of the security components.

Thereafter, the quantitative evaluating unit 110 extracts a data set which is suitable for the priority of the security policies based on the security function which is defined in the grouping process of the security components by using the indicator value of each group of the security components, the indicator value being calculated by the indicator calculating unit 108. Then, the quantitative evaluating unit 110 evaluates quantitatively each of the security policies composed of combined various security components by calculating the data set with the total reward function in step S214.

The total reward function according to an embodiment of the present invention can be defined as the following mathematical equation 2.

$$σ ( {p}_{i} ) = {I}_{A} \cdot ψ ( {S}_{A} , {p}_{i} ) + {I}_{K} \cdot ψ ( {S}_{K} , {p}_{i} ) + {I}_{R} \cdot ψ ( {S}_{R} , {p}_{i} ) + {I}_{C} \cdot ψ ( {S}_{C} , {p}_{i} ) + {I}_{M} \cdot ψ ( {S}_{M} , {p}_{i} ) \qquad [ Mathematical Equation 2 ]$$

where Pᵢ is a security policy;

I is an indicator value (I_{A},Iₖ,I_{R},I_{C},I_{M}: indicator value according to an evaluation component);

A,K,R,C and M are evaluation features (A: Authentication, K: Key management, R: Replay protection of traffic, C: Confidentiality and M: Message Authenticity);

S_{A},Sₖ,S_{R},S_{C},S_{M} is a group of evaluation components;

ψ( ) is an evaluation result of evaluation component for each policy.

In the equation 2, the evaluation features are representative security evaluation features and the evaluation features can be modified and other evaluation feature can be added.

A matrix structure as shown in the following mathematical equation 3 can be formed by improving the above mathematical equation 2.

Here, the quantitative evaluation for the security policy according the security function can be performed by grouping the evaluation components (S_{A},Sₖ,S_{R},S_{C},S_{M}) and allocating the indicator value to each group.

$$\begin{matrix} & [ Mathematical Equation 3 ] \\ ( \begin{matrix}σ ( {p}_{1} ) \\ σ ( {p}_{2} ) \\ σ ( {p}_{3} ) \\ σ ( {p}_{4} ) \\ σ ( {p}_{5} ) \\ σ ( {p}_{6} ) \\ σ ( {p}_{7} ) \\ σ ( {p}_{8} ) \\ σ ( {p}_{9} ) \\ σ ( {p}_{10} ) \\ σ ( {p}_{11} ) \\ σ ( {p}_{12} ) \\ σ ( {p}_{13} ) \\ σ ( {p}_{14} ) \\ σ ( {p}_{15} )\end{matrix} ) = ( \begin{matrix}\sum α ∈ Q & {I}_{α} ( ω ( {S}_{α} , {u}_{f}^{0} ) + ω ( {S}_{α} , {v}_{g}^{1} ) \\ \sum α ∈ Q & {I}_{α} ( ω ( {S}_{α} , {u}_{f}^{1} ) + ω ( {S}_{α} , {v}_{g}^{1} ) \\ \sum α ∈ Q & {I}_{α} ( ω ( {S}_{α} , {u}_{f}^{2} ) + ω ( {S}_{α} , {v}_{g}^{2} ) \\ \sum α ∈ Q & {I}_{α} ( ω ( {S}_{α} , {u}_{f}^{3} ) + ω ( {S}_{α} , {v}_{g}^{3} ) \\ \sum α ∈ Q & {I}_{α} ( ω ( {S}_{α} , {u}_{f}^{4} ) + ω ( {S}_{α} , {v}_{g}^{6} ) \\ \sum α ∈ Q & {I}_{α} ( ω ( {S}_{α} , {u}_{f}^{4} ) + ω ( {S}_{α} , {v}_{g}^{3} ) \\ \sum α ∈ Q & {I}_{α} ( ω ( {S}_{α} , {u}_{f}^{5} ) + ω ( {S}_{α} , {v}_{g}^{3} ) \\ \sum α ∈ Q & {I}_{α} ( ω ( {S}_{α} , {u}_{f}^{5} ) + ω ( {S}_{α} , {v}_{g}^{4} ) \\ \sum α ∈ Q & {I}_{α} ( ω ( {S}_{α} , {u}_{f}^{5} ) + ω ( {S}_{α} , {v}_{g}^{5} ) \\ \sum α ∈ Q & {I}_{α} ( ω ( {S}_{α} , {u}_{f}^{6} ) + ω ( {S}_{α} , {v}_{g}^{3} ) \\ \sum α ∈ Q & {I}_{α} ( ω ( {S}_{α} , {u}_{f}^{6} ) + ω ( {S}_{α} , {v}_{g}^{4} ) \\ \sum α ∈ Q & {I}_{α} ( ω ( {S}_{α} , {u}_{f}^{6} ) + ω ( {S}_{α} , {v}_{g}^{5} ) \\ \sum α ∈ Q & {I}_{α} ( ω ( {S}_{α} , {u}_{f}^{5} ) + ω ( {S}_{α} , {v}_{g}^{6} ) \\ \sum α ∈ Q & {I}_{α} ( ω ( {S}_{α} , {u}_{f}^{7} ) + ω ( {S}_{α} , {v}_{g}^{8} ) \\ \sum α ∈ Q & {I}_{α} ( ω ( {S}_{α} , {u}_{f}^{7} ) + ω ( {S}_{α} , {v}_{g}^{9} )\end{matrix} ) & \end{matrix}$$

Here, when a security function which a security manager emphasizes for the total networks is considered, e.g., when it is assumed that a security function having the characteristic of group f in the mathematical equation 3 is emphasized, the security policy Pi can be ordered as shown in the following mathematical equation 4.

σ(p0)<σ(p1)<σ(p2)<σ(p3)<σ(p4),

σ(p0)<σ(p5)<σ(p6)<σ(p13)<σ(p8)<σ(p7),

σ(p13)<σ(p9)<σ(p7),

σ(p13)<σ(p11)<σ(p7),

σ(p13)<σ(p12)<σ(p7),

σ(p9)<σ(p10),

σ(p11)<σ(p10),

σ(p12)<σ(p10), and

σ(p14)<σ(p15) [Mathematical Equation 4]

Namely, it is possible to extract the data set for the indicator value for the security policy as ordered in the above, and evaluate quantitatively the security policies which are composed of combined various security components.

As described above, more effective security management can be obtained by evaluating quantitatively the security polices which are composed of the combined various security components in heterogeneous networks through the unified evaluation criterion and the quantitative evaluation model in environment where various security policies are defined according to the present invention.

In addition, in contrast to the conventional method where the utility function should be amended arbitrarily when the contradiction for the result value of the total reward function as the quantitative evaluation method is occurred, more effective quantitative evaluation can be obtained by the modeling process since the reverse calculation is not needed according to the present invention.

Furthermore, according to the present invention, since the security polices support not only one function but also various security functions, effective adaptation for service for each of the security functions is possible and the occurrence of the contradiction due to simple summation for the security policy evaluation or the occurrence of the contradiction due to allocating arbitrary indicator value can be prevented since the indicator value set for the security components is extracted.

While the invention has been shown and described with respect to the embodiments, it will be understood by those skilled in the art that various changes and modification may be made without departing from the scope of the invention as defined in the following claims.

What is claimed is:

1. An apparatus for quantitatively evaluating security policy, comprising:
a security policy analyzing unit for analyzing a security policy of a network;
an evaluation criterion defining unit for defining an evaluation criterion for categorizing security features as evaluation feature and evaluating each of the security features;
an evaluation result calculating unit for calculating an evaluation result of each of security components based on the evaluation criterion for each of the security features;
an indicator calculating unit for categorizing and grouping the security components according to a security function and calculating an indicator by considering a security function of each group; and
a quantitative evaluating unit for evaluating a security policy of the each group by using the indicator.

2. The apparatus of claim 1, wherein the security policy analyzing unit analyzes the security policy which is composed of combined various security components in heterogeneous networks and categorizes the security policy into a minimum security component.

3. The apparatus of claim 1, wherein the evaluation result calculating unit digitizes each of the security components by using a utility function based on an evaluation criterion for each of the security components and calculates an evaluation result as a result value by putting together numerical values of the utility function.

4. The apparatus of claim 1, wherein the quantitative evaluating unit extracts a data set which is suitable for a priority of security policies based on the security function which is defined in a grouping process of the security components, evaluates quantitatively the security policies composed of combined various security components and determines ranking of the security policies.

5. The apparatus of claim 4, wherein the quantitative evaluating unit performs a quantitative evaluation for each of the security policies composed of combined various security components by calculating the data set with a total reward function.

6. A method for quantitatively evaluating security policy, comprising:
analyzing a security policy of a network;
defining an evaluation criterion for categorizing security features as an evaluation feature and evaluating each of the security features;
calculating an evaluation result of each security component based on the evaluation criterion for each of the security features;
categorizing and grouping the security component according to a security function and calculating an indicator by considering the security function of each group; and
evaluating quantitatively a security policy of the each group by using the indicator.

7. The method of claim 6, wherein said analyzing the security policy includes:
analyzing the security policy which is composed of combined various security components in heterogeneous networks; and
categorizing the security policy into a minimum security component by the analyzing.

8. The method of claim 6, wherein said calculating the evaluation result includes:
digitizing each of the security components by using a utility function based on an evaluation criterion for each of the security components; and
calculating an evaluation result as a result value by putting together numerical values of the utility function.

9. The method of claim 6, wherein said evaluating quantitatively the security policy includes:
extracting a data set which is suitable for a priority of security policies based on the security function which is defined in a grouping process of the security components;
evaluating quantitatively the security policies composed of combined various security components; and
determining ranking of the security policies. 10

10. The method of claim 9, wherein a quantitative evaluation for each of the security policies composed of combined various security components is performed by calculating the data set with a total reward function in the evaluating quantitatively the security policy.
